(19) United States
(12) Patent Application Publication
(10) Pub. No.: US 2026/0330861 A1
(43) Pub. Date: Oct. 22, 2026

(54) Document Review System with Syntax and Policy Compliance Checking

(71) Applicant: ConductorAI Corporation, New York, NY (US)

(72) Inventors: Zachary Long, New York, NY (US); Benjamin Fichter, Biddeford, ME (US); Eric Schwartz, Brooklyn, NY (US); Jason Cardinale, New York, NY (US); Vincent Le, New York, NY (US); Gautam Mekkat, Poughkeepsie, NY (US); Rami Pellumbi, New York, NY (US); Jordan Gallivan, St. Augustine, FL (US); Jessica Shu, New York, NY (US)

(73) Assignee: ConductorAI Corporation, New York, NY (US)

(21) Appl. No.: 19/180,345

(22) Filed: Apr. 16, 2025

(51) Int. Cl. G06V 30/412; G06F 9/451; G06F 40/103; G06Q 30/018

(52) U.S. Cl. CPC G06V 30/412; G06F 9/451; G06F 40/103; G06Q 30/018

(57) ABSTRACT

A document review and approval system displays a graphical user interface. The system comprises a source selector component receiving source documents, an objective definer component receiving user-defined objectives, and a corpus selector component receiving policy documents. An artificial intelligence engine processes inputs from these components. A syntax auditor component identifies syntax errors in the source documents based on the user-defined objectives. A policy auditor component identifies policy non-compliance issues related to source documents. A reporter component generates reports based on identified syntax errors and policy non-compliance issues. The system enables comprehensive document review and approval, integrating syntax checking, policy compliance analysis, and report generation in a user interface guided by artificial intelligence.

### FIELD OF INVENTION

The present disclosure relates to document review and approval systems, and more particularly to a graphical user interface that interfaces with an artificial intelligence engine to facilitate comprehensive document review, syntax checking, policy compliance analysis, and report generation.

### BACKGROUND

The process of preparing and submitting applications for various purposes, such as disclosing sensitive information or grant proposals, often involves complex requirements that must be carefully followed. These requirements typically encompass both syntax and policy guidelines, which are crucial for the application's success and compliance with relevant regulations.

In the context of disclosing sensitive information, for example, government agencies and organizations must navigate an intricate process designed to protect sensitive information while facilitating necessary international cooperation. This process generally involves multiple steps, including document preparation and marking, initial review, submission to a designated approval authority, policy compliance checks, and coordination with other agencies when necessary. Throughout this process, attention to both syntax (e.g., proper classification markings and formatting) and policy (e.g., compliance with national disclosure policies and export regulations) is critical.

Similarly, when drafting proposals or other strategic documents, applicants must adhere to specific formatting guidelines while also ensuring their proposed work aligns with a company's or agency's policies and priorities. This dual focus on syntax and policy compliance is common across many types of application processes, including patent applications, regulatory filings, and academic submissions.

The current state of the art in document review and compliance checking is characterized by a fragmented approach that fails to address the complex needs of users who require both syntax and policy compliance in a single, integrated system. While there are numerous tools available for specific aspects of document review, such as spelling and grammar checkers for basic syntax issues, they fall short in providing a comprehensive solution that can handle the nuanced requirements of specialized application processes.

Existing solutions often lack the ability to customize syntax rules based on user-defined objectives, incorporate a corpus of policy documents against which to check compliance, or generate comprehensive reports about the review and approval process. This lack of integration forces users to rely on multiple tools and manual processes, leading to inefficiencies, increased risk of errors, and potential compliance issues.

Furthermore, while artificial intelligence and natural language processing technologies have made significant advancements in recent years, their application to the specific challenges of document review and approval processes remains limited. There is a need for novel graphical user interfaces that can leverage these technologies to provide a more intuitive, efficient, and comprehensive approach to syntax and policy compliance checking.

As the complexity of application processes continues to grow, along with the volume of documents that need to be reviewed and approved, there is an increasing demand for innovative solutions that can streamline these workflows while maintaining high standards of accuracy and compliance. Such solutions could potentially revolutionize how organizations handle document review and approval processes across various domains, from government agencies to academic institutions and private sector enterprises.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a document review and approval system is provided. The system includes a processor and a memory for storing machine executable program code. The system includes a user interface component comprising machine executable program code that, when executed by the processor, causes the user interface component to display a graphical user interface. The system includes a source selector component comprising machine executable program code that, when executed by the processor, causes the source selector component to receive one or more source documents selected by a user through the graphical user interface. The system includes an objective definer component comprising machine executable program code that, when executed by the processor, causes the objective definer component to receive one or more user-defined objectives from the user for document review through the graphical user interface, wherein the one or more user-defined objectives include one or more intended recipients and one or more approvers. The system includes a corpus selector component comprising machine executable program code that, when executed by the processor, causes the corpus selector component to receive one or more policy documents selected by the user through the graphical user interface, wherein the one or more policy documents include one or more policies related to permissible content. The system includes an artificial intelligence engine component comprising machine executable program code that, when executed by the processor, causes the artificial intelligence engine component to process inputs from the source selector component, objective definer component, and corpus selector component and provide corresponding output. The system includes a syntax auditor component comprising machine executable program code that, when executed by the processor, causes the syntax auditor component to identify one or more syntax errors in the one or more source documents based on the output from the artificial intelligence engine, wherein the one or more syntax errors include at least one of a formatting or structural error with the one or more source documents based on the one or more user-defined objectives. The system includes a policy auditor component comprising machine executable program code that, when executed by the processor, causes the policy auditor component to identify one or more policy non-compliance issues related to the one or more source documents based on the output from the artificial intelligence engine, wherein the one or more policy non-compliance issues include content in the one or more source documents that is violative of one or more of the policies related to permissible content. The system includes a reporter component comprising machine executable program code that, when executed by the processor, causes the reporter component to generate one or more reports based on the identified syntax errors and policy non-compliance issues from the syntax auditor component and policy auditor component respectively.

According to other aspects of the present disclosure, the system may include one or more of the following features. The machine executable program code of the reporter component may cause the reporter component to customize report content based on the one or more user-defined objectives received through the objective definer component and incorporate natural language summaries and explanations generated by the artificial intelligence engine component. The machine executable program code of the corpus selector component may cause the corpus selector component to semantically search across a database of policy documents to identify one or more relevant policy documents based on the one or more user-defined objectives. The user interface component may further comprise a document presenter component comprising machine executable program code that, when executed by the processor, causes the document presenter component to display content of the one or more source documents alongside identified syntax errors and policy non-compliance issues. The artificial intelligence engine component may comprise a large language model comprising machine executable program code that, when executed by the processor, generates natural language explanations for identified syntax errors and policy non-compliance issues. The machine executable program code of the artificial intelligence engine component may further cause the artificial intelligence engine component to recommend one or more relevant policy documents based on the content of the one or more source documents and the one or more user-defined objectives. The machine executable program code of the artificial intelligence engine component may further cause the artificial intelligence engine component to create an expert network by analyzing metadata from previously approved documents to identify patterns and relationships between document types, topics, and approvers. The machine executable program code of the reporter component may further cause the reporter component to generate approval stamps or markings and apply them directly to the one or more source documents to indicate their review status and/or approval. The machine executable program code of the user interface component may cause the user interface component to guide users through multiple stages of a review process, including selecting source documents, defining objectives, reviewing syntax errors, selecting a corpus, reviewing policy non-compliance, and generating reports. The user interface component may comprise a rule creation element comprising machine executable program code that, when executed by the processor, causes the rule creation element to allow users to define one or more rules in plain language, and wherein the machine executable program code of the artificial intelligence engine component causes the artificial intelligence engine component to process these one or more user-defined rules and incorporate them into one or more of the syntax auditor component and policy auditor component for document evaluation.

According to another aspect of the present disclosure, a method for document review and approval is provided. The method includes displaying a graphical user interface. The method includes receiving, through the graphical user interface, one or more source documents selected by a user. The method includes receiving, through the graphical user interface, one or more user-defined objectives from the user for document review, wherein the one or more user-defined objectives include one or more intended recipients and one or more approvers. The method includes receiving, through the graphical user interface, one or more policy documents selected by the user, wherein the one or more policy documents include one or more policies related to permissible content. The method includes processing, by an artificial intelligence engine, inputs from the received source documents, user-defined objectives, and policy documents. The method includes identifying, based on output from the artificial intelligence engine, syntax errors in the one or more source documents, wherein the one or more syntax errors include at least one of a formatting or structural error with the one or more source documents based on the one or more user-defined objectives. The method includes identifying, based on output from the artificial intelligence engine, policy non-compliance issues related to the one or more source documents, wherein the one or more policy non-compliance issues include content in the one or more source documents that is violative of one or more of the policies related to permissible content. The method includes generating one or more reports based on the identified syntax errors and policy non-compliance issues.

According to other aspects of the present disclosure, the method may include one or more of the following features. The method may include customizing report content based on the one or more user-defined objectives and incorporating natural language summaries and explanations generated by the artificial intelligence engine into the one or more reports. The method may include semantically searching across a database of policy documents to identify one or more relevant policy documents based on the one or more user-defined objectives. The method may include displaying content of the one or more source documents alongside identified syntax errors and policy non-compliance issues. The artificial intelligence engine may comprise a large language model, and the method may further include generating, by the large language model, natural language explanations for identified syntax errors and policy non-compliance issues. The method may include recommending, by the artificial intelligence engine, one or more relevant policy documents based on the content of the one or more source documents and the one or more user-defined objectives. The method may include creating, by the artificial intelligence engine, an expert network by analyzing metadata from previously approved documents to identify patterns and relationships between document types, topics, and approvers. The method may include generating approval stamps or markings and applying the approval stamps or markings directly to the one or more source documents to indicate their review status and/or approval. The method may include guiding users through multiple stages of a review process, including selecting source documents, defining objectives, reviewing syntax, selecting a corpus, reviewing policy compliance, and generating reports. The method may include receiving, through the graphical user interface, one or more user-defined rules in plain language, processing, by the artificial intelligence engine, the one or more user-defined rules, and incorporating the processed user-defined rules into one or more of a syntax auditor and a policy auditor for document evaluation.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a document review and approval system, according to aspects of the present disclosure.

FIG. 2A illustrates a user interface for selecting a source document, according to an embodiment.

FIG. 2B illustrates a user interface for defining objectives in a document review system, according to an aspect of the present disclosure.

FIG. 2C illustrates a user interface for reviewing syntax in a document, according to an embodiment.

FIG. 2D illustrates a user interface for selecting a corpus in a document review system, according to aspects of the present disclosure.

FIG. 2E illustrates a user interface for reviewing policy compliance in a document, according to an embodiment.

FIG. 2F illustrates a user interface displaying policy findings in a document review system, according to aspects of the present disclosure.

FIG. 2G illustrates a user interface for generating a report in a document review system, according to an embodiment.

FIG. 3 illustrates a system diagram of a document review system, according to an embodiment.

FIG. 4 illustrates a flowchart of a method for document review and approval, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The document review and approval system described herein provides a comprehensive solution for reviewing and approving documents in accordance with both syntax and policy requirements. This system may be particularly useful in environments where document compliance with specific formatting rules and policy guidelines is critical, such as in government agencies or highly regulated industries.

The system may include a graphical user interface that allows users to interact with various components of a review process. In some cases, the graphical user interface may comprise a source selector, which may enable users to input or select documents for review. The graphical user interface may also include an objective definer, which may allow users to specify the goals or purposes of the document review. Additionally, the graphical user interface may feature a corpus selector, which may permit users to choose and/or upload relevant policy documents against which the source documents will be evaluated.

The system may process the inputs provided through the graphical user interface using advanced artificial intelligence techniques. This processing may involve analyzing the source documents, interpreting the user-defined objectives, and examining the selected policy documents to identify potential issues or areas of concern.

Following the analysis, the system may present its findings in the graphical user interface through various output interfaces. These output interfaces may include a syntax auditor, which may identify and help correct formatting or structural errors in the source documents. The output interfaces may also comprise a policy auditor, which may highlight areas where the content of the source documents may not comply with the specified policies. Furthermore, the output interfaces may include a reporter, which may generate summaries or detailed reports based on the findings of the syntax and policy audits.

By combining these various components, the document review and approval system may streamline the process of ensuring document compliance, potentially reducing the time and effort required for thorough document reviews while maintaining a high standard of accuracy and consistency.

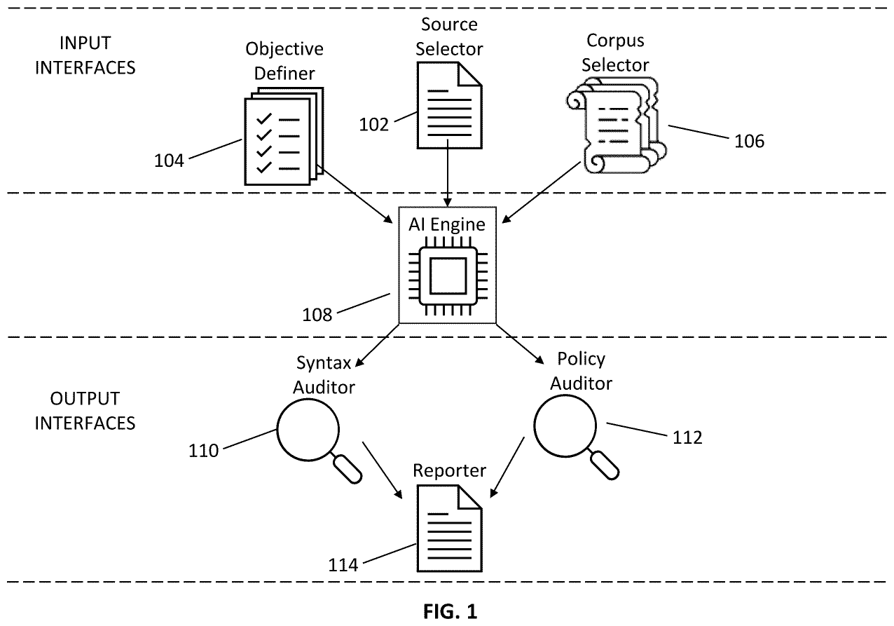

FIG. 1 illustrates a block diagram of a document review and approval system in accordance with aspects of the present disclosure. The system may comprise three main sections: input interfaces, an artificial intelligence (AI) engine, and output interfaces.

The input interfaces may include a source selector 102, an objective definer 104, and a corpus selector 106. The source selector 102 may allow users to select or upload documents for processing. The objective definer 104 may enable users to define the objectives for their review request. The corpus selector 106 may permit users to search for and select relevant policies and/or policy documents.

At the center of the system may be the AI engine 108, which may process the inputs from the source selector 102, objective definer 104, and corpus selector 106. The AI engine 108 may perform analysis and generate outputs based on the provided inputs.

The output interfaces may consist of a syntax auditor 110, a policy auditor 112, and a reporter 114. The syntax auditor 110 may identify and help fix syntax errors in the source documents. The policy auditor 112 may identify non-compliance issues with policies. The reporter 114 may generate reports, summaries, or memorandums based on the findings of the syntax and policy auditors.

This structure may allow for a workflow that begins with document and objective input, proceeds through AI-powered analysis, and concludes with detailed auditing and reporting. The system may provide a comprehensive approach to document review and approval, integrating syntax checking, policy compliance, and reporting functionalities within a single platform.

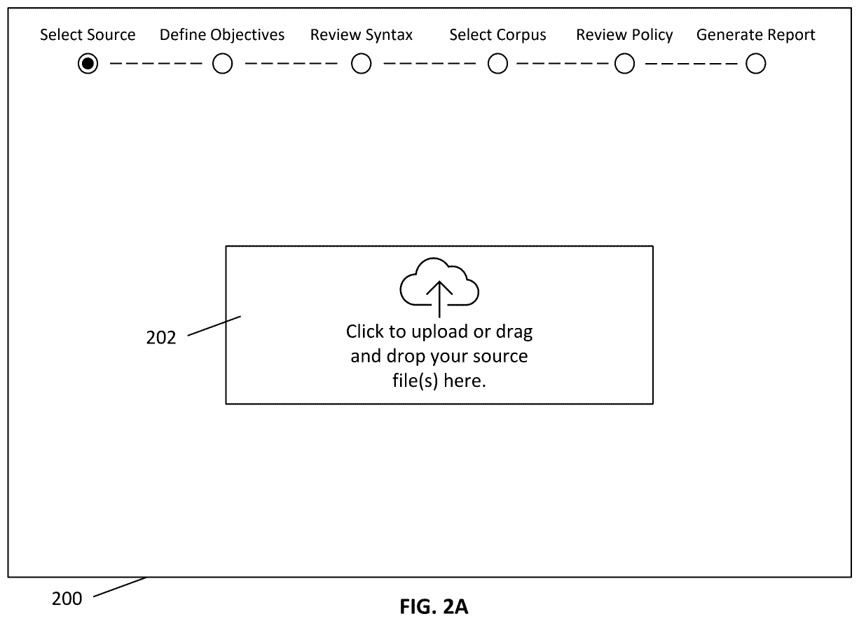

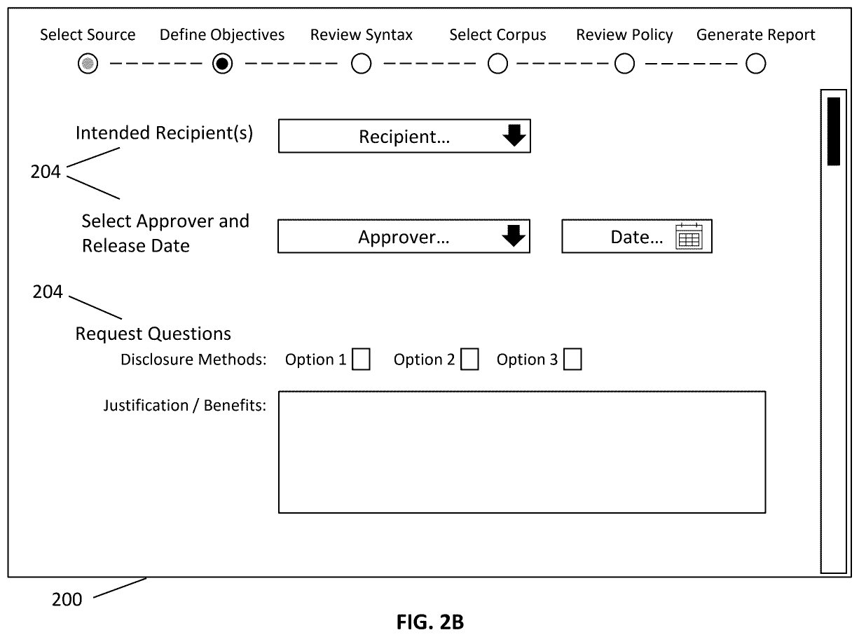

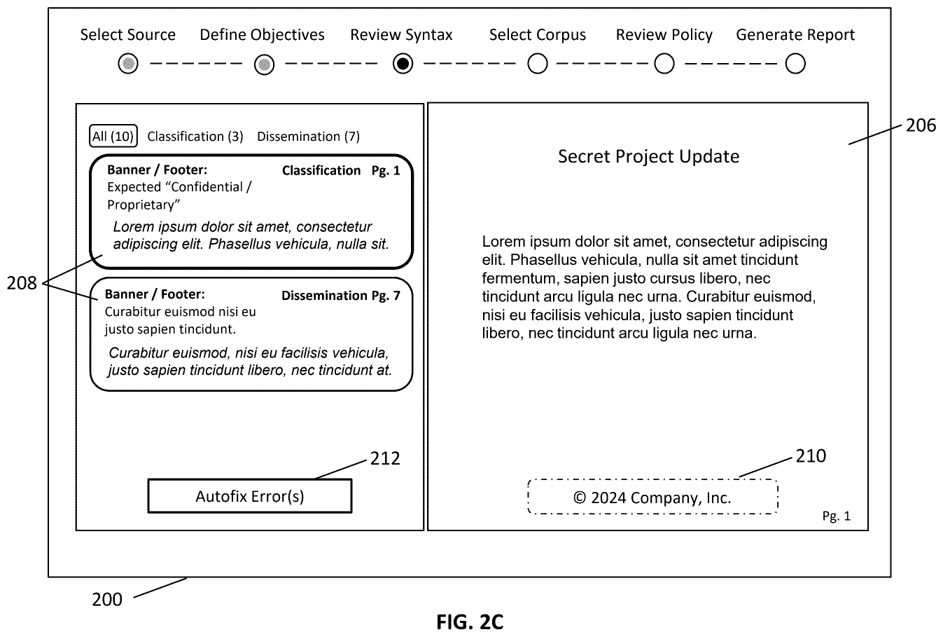

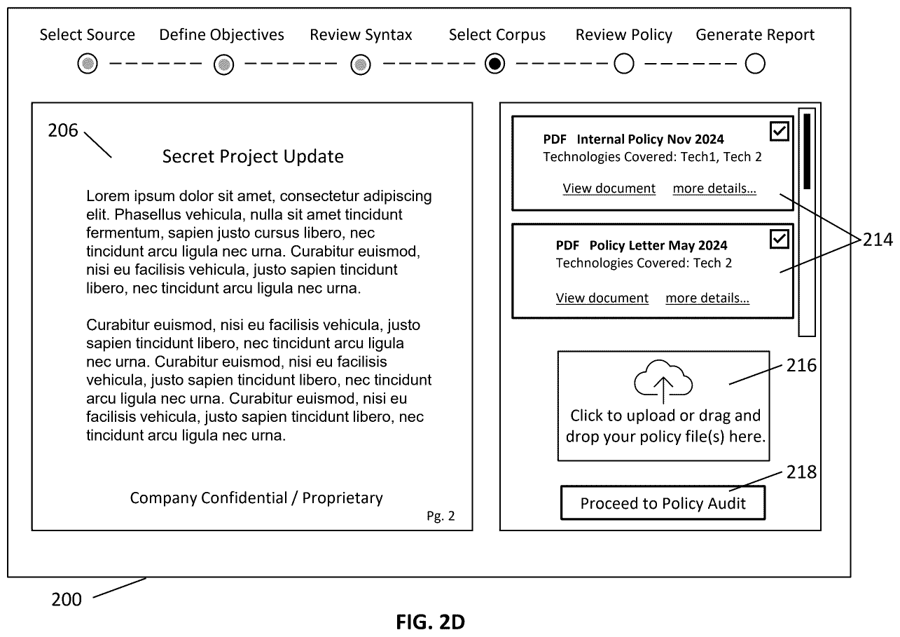

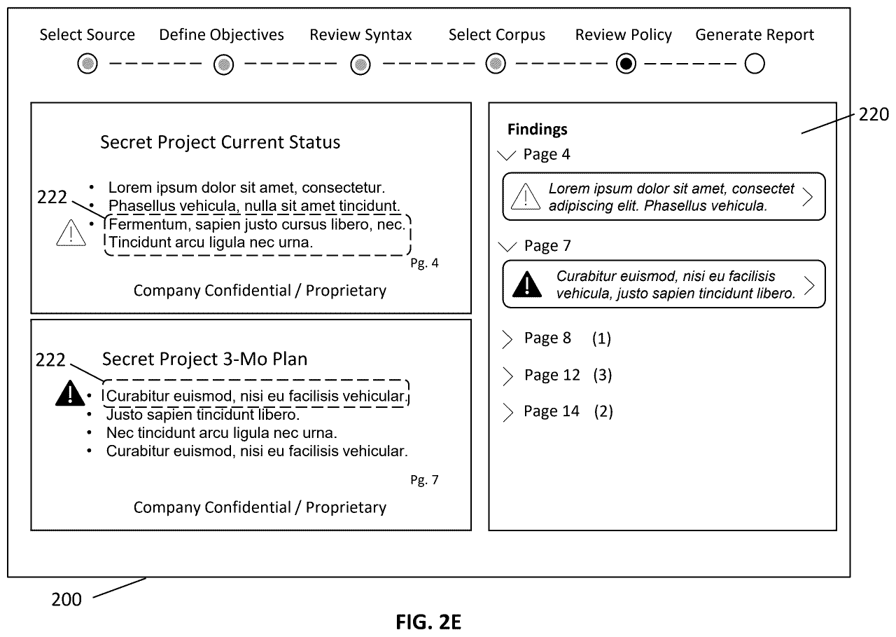

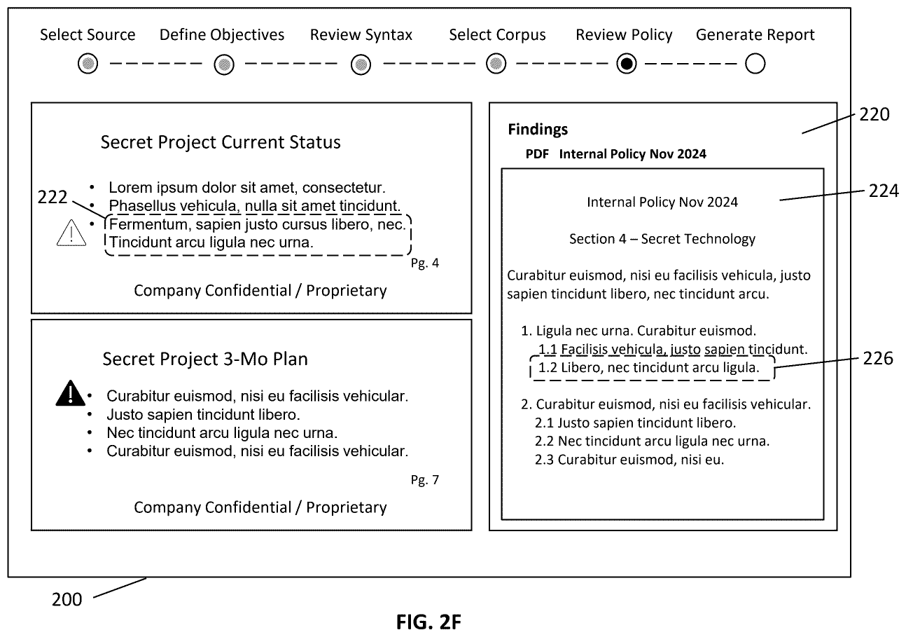

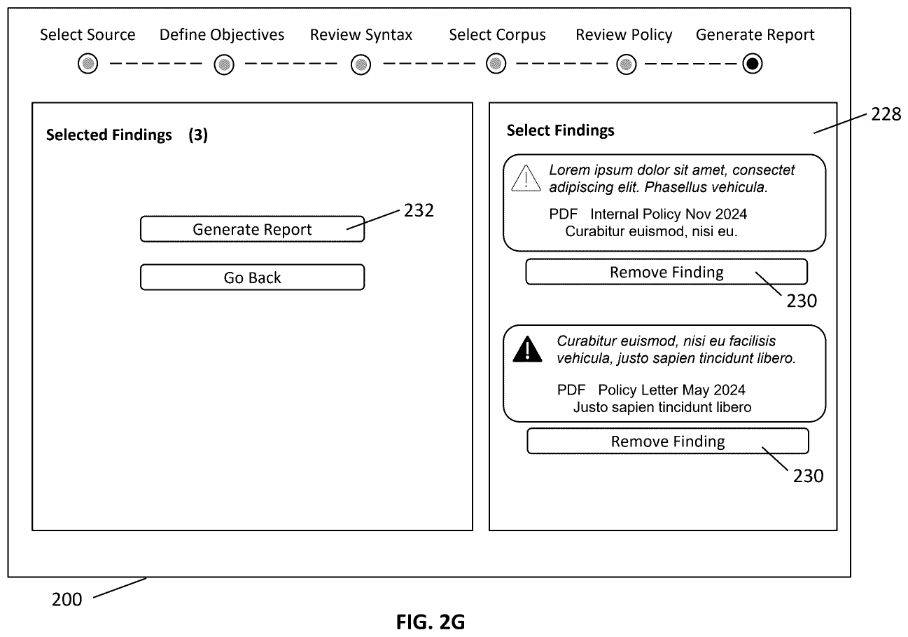

Embodiments of the document review and approval system may include a graphical user interface 200 that integrates various components and guides users through the review process. FIG. 2A illustrates a graphical user interface displaying a workflow process with multiple steps, including “Select Source,” “Define Objectives,” “Review Syntax,” “Select Corpus,” “Review Policy,” and “Generate Report.”

The graphical user interface 200 may guide users through different stages of the review process. In the initial stage, as shown in FIG. 2A, users may interact with the source selector element 202 to upload or select source documents for review. The source selector element 202 may provide options for clicking to upload or dragging and dropping files.

FIG. 2B illustrates the next stage where users may interact with the objective definer elements 204. The objective definer elements 204 may include dropdown menus, date pickers, checkboxes, text entry fields, and other input elements for users to define their review objectives.

In the syntax review stage, as shown in FIG. 2C, users may interact with the syntax error presenter 208 and the autofix element 212. The syntax error presenter 208 may display identified syntax errors, while the autofix element 212 may allow users to automatically correct these errors.

FIG. 2D shows the corpus selection stage, where users may interact with the corpus selector element 214 and the corpus uploader element 216. These elements may allow users to select existing policy documents or upload new ones. The policy auditor element 218 may then initiate the policy compliance check.

In the policy review stage, illustrated in FIG. 2E and FIG. 2F, users may interact with the finding presenter 220. The finding presenter 220 may display policy-related findings, with finding indicators 222 highlighting specific areas of concern in the document. The policy presenter 224 may show relevant policy documents, with policy indicators 226 emphasizing specific policy sections.

The final stage, shown in FIG. 2G, may involve report generation. Users may interact with the finding selector 228 to review findings, use the finding remover element 230 to remove specific findings, and activate the report generator element 232 to create reports based on the review process.

It should be understood that the ordering of stages described herein is exemplary only, and that the stages may be presented in a different order, with two or more stages combined to a single stage, and with any stage split into multiple stages without departing from the scope of the present disclosure.

Each of the components of the document review and approval system may be described in more detail below together with one or more alternative embodiments.

As discussed above, the document review and approval system may include a source selector 102. In some cases, the source selector 102 may be configured to receive one or more source documents. The source selector 102 may provide users with multiple options for inputting documents into the system for review and approval.

FIG. 2A shows a graphical user interface that includes a source selector element 202. In some cases, the source selector element 202 may provide users with the ability to upload files directly from their local computer or select files from the cloud or other networked resource. Users may click on the source selector element 202 to open a file browser dialog, enabling them to navigate a file system and select one or more documents for input to the system.

The source selector element 202 may also support drag-and-drop functionality. Users may drag files from their computer's file explorer and drop them onto the source selector element 202 to initiate the upload process. This feature may provide a quick and intuitive method for adding documents to the system.

In some cases, the source selector 102 may be capable of handling various file formats. For example, the source selector 102 may accept common document types such as PDF files, Microsoft Office documents, EML files, or plain text files. This versatility may allow users to review and approve a wide range of document types within the system.

The source selector 102 may also provide feedback to users during the document upload process. For instance, the source selector element 202 may display progress indicators or confirmation messages to inform users about the status of their uploads.

In some cases, the source selector 102 may allow users to select multiple documents simultaneously. This feature may be particularly useful when users need to review a set of related documents or when processing a batch of files for approval.

The source selector 102 may also include functionality to preview or verify the uploaded documents before proceeding with the review process. This may help users ensure they have selected the correct files before moving on to subsequent stages of the document review and approval workflow.

The document review and approval system may include an objective definer 104. In some cases, the objective definer 104 may be configured to receive user-defined objectives for document review. The objective definer 104 may provide users with a structured way to specify the goals, purposes, and/or relevant parties (e.g., other reviewers or approval authorities) of their document review process.

FIG. 2B shows a graphical user interface that includes objective definer elements 204. The objective definer elements 204 may comprise various input fields, dropdown menus, and selection options that allow users to define their objectives in a clear and organized manner.

In some cases, the objective definer elements 204 may be tailored to specific workflows or applications. For example, in a disclosure workflow, the objective definer elements 204 may include options for selecting intended recipients, specifying an approver and target release date, and indicating the intended disclosure methods.

The objective definer 104 may also accommodate objectives for other types of application processes. For instance, in a grant proposal review workflow, the objective definer elements 204 may include fields for specifying the funding agency, grant type, submission deadline, and key research areas.

In some cases, the objective definer 104 may allow users to input custom objectives or additional information. For example, the objective definer elements 204 may include a text input field for users to provide justification or explain the benefits of their request.

The objective definer 104 may be designed to capture all necessary information to guide the subsequent document review and approval process. By clearly defining objectives at the outset, the objective definer 104 may help ensure that the document review and approval system focuses on the most relevant aspects of syntax compliance and policy adherence.

In some cases, the objective definer 104 may dynamically adjust the available options based on user inputs. For example, selecting a specific type of disclosure in a disclosure workflow may trigger the appearance of additional, relevant objective definer elements 204.

The objective definer 104 may work in conjunction with other components of the document review and approval system. For instance, the objectives defined using the objective definer 104 may inform the selection of relevant policy documents by the corpus selector, or guide the analysis performed by the AI engine.

In some cases, the objective definer element may be implemented as a free text entry field. This approach may provide users with flexibility to express their objectives in their own words. The AI engine may then employ natural language processing (NLP) techniques to analyze the free-form text input and determine the relevant objectives.

Based on this analysis, the AI engine may identify and extract key information from the user's input. This extracted information may be used to infer the appropriate syntax rules and policy considerations for the document review process. For example, if a user mentions “disclosure” in their free text entry, the AI engine may recognize this as a cue to apply specific syntax rules related to classification markings and distribution statements.

The AI engine may also use NLP to identify entities, relationships, and intentions expressed in the free text input. This may allow the system to automatically select relevant policy documents or adjust the review criteria based on the user's stated objectives. For instance, if the user mentions a particular country or organization in their objectives, the AI engine may prioritize policies related to that entity during the review process.

By leveraging NLP capabilities, the objective definer may provide a more intuitive and user-friendly interface while still capturing the necessary information to guide the document review process. This approach may be particularly useful in cases where users are unsure of the specific options or categories that best describe their objectives, or when dealing with unique or complex review scenarios that may not fit neatly into predefined categories.

The document review and approval system may include a syntax auditor 110. FIG. 1 illustrates the syntax auditor 110 as part of the output interfaces of a document review and approval system.

In some cases, the syntax auditor 110 may be configured to identify and facilitate correction of syntax errors in the source documents received through the source selector 102. The syntax auditor 110 may analyze the content and structure of the source documents to detect various types of syntax issues.

FIG. 2C shows a graphical user interface that includes document presenter 206 and a syntax error presenter 208. The document presenter 206 may display the content of a source document being reviewed and may be configured to display content of the source documents alongside identified syntax errors and policy non-compliance issues. The syntax error presenter 208 may display identified syntax errors alongside the content of the source document in the document presenter 206. This side-by-side presentation may allow users to easily locate and understand the context of each syntax error.

In some cases, the syntax error presenter 208 may categorize syntax errors by type. For example, FIG. 2C shows two sections in the syntax error presenter 208: one related to “Classification” and another related to “Dissemination.” This categorization may help users quickly identify and address specific types of syntax issues.

In some embodiments, the syntax auditor may expressly exclude common spelling and grammar errors from its analysis. Instead, the syntax auditor may focus on syntax rules that are specifically related to the user-defined objectives. This approach may allow the system to tailor its syntax checking to the particular requirements of each document review process.

The syntax rules applied by the syntax auditor may vary depending on the circumstances and objectives defined by the user. For example, if the user-defined objectives indicate that the document is intended for a specific type of disclosure or regulatory filing, the syntax auditor may apply rules that are relevant to that particular context. This may include checking for proper formatting of classification markings, correct use of distribution statements, or adherence to specific document structure requirements.

In some cases, the syntax rules may be dynamically generated or selected based on the analysis of the user-defined objectives by the AI engine. This may allow the syntax auditor to adapt its checking criteria to a wide range of document types and review scenarios, providing more relevant and context-specific syntax analysis.

By focusing on objective-specific syntax rules rather than general spelling and grammar, the syntax auditor may provide more valuable insights into the document's compliance with relevant formatting and structural requirements. This approach may help users address syntax issues that are most critical to their specific document review and approval needs.

The graphical user interface 200 may also include a syntax error indicator 210 within the document content area of the document presenter 206. The syntax error indicator 210 may highlight or otherwise visually mark the specific portions of the document where syntax errors (i.e., the syntax errors in the syntax error presenter 208) have been identified. This feature may provide users with a clear visual representation of where errors occur within the context of the full document.

In some cases, the syntax auditor 110 may be configured to automatically correct identified syntax errors in the source documents. The graphical user interface 200 may include an autofix element 212, as shown in FIG. 2C. The autofix element 212 may allow users to initiate automatic correction of identified syntax errors.

The syntax auditor 110 may be capable of making corrections directly within the source document itself. For example, the syntax auditor 110 may modify a PDF, Google Document, or Microsoft Office file to correct syntax errors. This may involve changing actual text, adjusting formatting, or modifying document properties to ensure compliance with syntax rules.

In some aspects, the syntax auditor 110 may automatically correct identified syntax errors while simultaneously marking the corrected areas in the document content area with syntax error indicators 210. This approach may allow users to review the automated corrections before finalizing the document.

The syntax auditor 110 may apply corrections to the source document based on predefined rules or AI-generated suggestions. As it makes these corrections, it may insert syntax error indicators 210 at the locations of the corrected errors. These indicators may take various forms, such as highlighted text, underlined text, or marginal notes, depending on the document format and user preferences.

Users may interact with the syntax error indicators 210 to review the automated corrections. In some cases, hovering over or clicking on a syntax error indicator 210 may display information about the original error and the applied correction. This information may include the type of error, the original text, and the corrected text.

The graphical user interface 200 may provide options for users to accept, decline, or revise each automatically corrected syntax error. Users may be able to cycle through the corrections using keyboard shortcuts or navigation buttons within the interface.

In some implementations, the syntax auditor 110 may track user decisions on automated corrections. This data may be used to improve future automated correction suggestions and to generate reports on common syntax issues within an organization.

The system may also provide a summary view of all automated corrections, allowing users to quickly review and batch process multiple changes. This feature may be particularly useful for documents with numerous syntax errors or for users who prefer to review all changes at once.

By combining automated correction with user review, the syntax auditor 110 may streamline the process of fixing syntax errors while maintaining user control over the final document content. This approach may help balance efficiency with accuracy in document review and approval workflows.

In some cases, users may be able to configure a set of syntax rules to be applied to a document. These rules may be predefined, automatically selected by the AI engine 108 based on the objectives defined through the objective definer 104, or generated by the AI engine 108 based on the defined objectives.

The syntax auditor 110 may address various types of common syntax issues. For example:
1. Disclosure markings: The syntax auditor 110 may check for proper placement, formatting, and consistency of disclosure markings throughout the document.
2. Page numbering: The syntax auditor 110 may ensure that page numbers are present, correctly formatted, and sequential.
3. Headers and footers: The syntax auditor 110 may verify that headers and footers contain required information and are consistently formatted across all pages.
4. Paragraph numbering: The syntax auditor 110 may check for proper numbering or lettering of paragraphs and subparagraphs.
5. Font and formatting: The syntax auditor 110 may ensure that the document uses approved fonts, font sizes, and formatting styles.
6. Distribution statements: The syntax auditor 110 may verify that appropriate distribution statements are included and properly formatted.

In some cases, the syntax auditor 110 may work in conjunction with the AI engine 108 to provide context-aware syntax checking. For example, the AI engine 108 may analyze the content of the document and the objectives defined through the objective definer 104 to determine which syntax rules are most relevant for a particular document review.

The syntax auditor 110 may also provide explanations for identified syntax errors. These explanations may help users understand why a particular syntax issue needs to be addressed and how to correct it properly.

By combining automated syntax checking, clear error presentation, and the ability to automatically correct errors, the syntax auditor 110 may significantly streamline the process of ensuring document compliance with syntax requirements.

The document review and approval system may include a corpus selector 106. FIG. 1 illustrates the corpus selector 106 as part of the graphical user interface 200 of a document review and approval system.

In some cases, the corpus selector 106 may be configured to receive one or more policy documents. The corpus selector 106 may provide users with multiple options for inputting, searching for, and selecting relevant policy documents to be used in the review process.

FIG. 2D shows a graphical user interface 200 that includes a corpus selector element 214 and a corpus uploader element 216. The corpus selector element 214 may display a list of policy documents relevant to the review process. The corpus uploader element 216 may allow users to upload additional policy files by clicking or dragging and dropping files.

In some cases, the document review and approval system may include a search functionality that permits users to identify documents that they should include in the policy corpus. The search functionality may support semantic search across data by chunking and creating embeddings that are then stored in a vector database.

The corpus selector 106 may be configured to semantically search across a database of policy documents to identify relevant policy documents based on the user-defined objectives. In some cases, users may perform text-based searches and/or search by uploading one or more document(s).

When users search by uploading documents, the document review and approval system may allow users to view both the uploaded document(s) and the referenced results side-by-side. This feature may assist users in comparing and selecting relevant policy documents for their review process.

The document review and approval system may return search results with relevant information including direct links to specific documents, pages, and portions, along with extracted metadata. This information may help users quickly identify the most pertinent policy documents for their review objectives.

In some cases, the document review and approval system may identify semantically related documents to assist the user with defining a relevant and comprehensive policy corpus. This feature may leverage the AI engine to analyze the content of policy documents and identify relationships between them.

The corpus selector 106 may work in conjunction with other components of the document review and approval system. For example, the AI engine may recommend corpus documents based on policies related to the objective(s) previously defined by the user using the objective definer 104 and/or the source document(s) uploaded through the source selector 102.

The corpus of policy documents may include various types of documents relevant to the review process. These may include, but are not limited to, official policy statements, regulatory guidelines, internal procedures, previous approval documents, and relevant legal texts. By allowing users to select and upload a diverse range of policy documents, the corpus selector 106 may enable a comprehensive and context-specific review process.

The document review and approval system may include an AI engine 108. FIG. 1 illustrates the AI engine 108 as a component of a document review and approval system.

In some cases, the AI engine 108 may be configured to process the source documents received through the source selector 102, user-defined objectives input via the objective definer 104, and policy documents selected using the corpus selector 106. The AI engine 108 may analyze these inputs to identify potential syntax errors, policy non-compliance issues, and generate relevant outputs for the document review process.

The AI engine 108 may include a Natural Language Processing (NLP) component and a large language model (LLM). The NLP component may enable the AI engine 108 to understand and interpret the content of source documents, user objectives, and policy documents. NLP refers to a branch of artificial intelligence that focuses on the interaction between computers and human language, employing computational techniques to analyze, understand, and generate human language. The NLP component may utilize various techniques such as tokenization (breaking text into words or phrases), part-of-speech tagging (identifying grammatical components), named entity recognition (identifying proper nouns), and syntactic parsing (analyzing sentence structure) to process and extract meaning from text. The LLM may allow the AI engine 108 to process natural language inputs and generate natural language outputs. LLMs are sophisticated neural network architectures trained on vast corpora of text data that learn statistical patterns in language to predict and generate contextually appropriate text. These models typically employ transformer architectures with attention mechanisms that enable them to capture long-range dependencies and contextual relationships between words. LLMs function by converting words into numerical vectors (embeddings) that represent semantic meaning, then processing these vectors through multiple layers of neural networks to understand context and generate coherent, contextually appropriate responses.

In some cases, the AI engine 108 may apply machine learning techniques to improve its performance over time. For example, the AI engine 108 may learn from previous document reviews to better identify common syntax errors or policy violations in future reviews.

The AI engine 108 may use its NLP capabilities to analyze the content of source documents and compare it against relevant policy documents. This analysis may help identify potential non-compliance issues that may not be apparent through simple keyword matching.

In some cases, the LLM within the AI engine 108 may be configured to generate explanations for identified syntax errors and policy non-compliance issues. These explanations may provide users with clear, context-specific information about why certain parts of a document may not comply with syntax rules or policy guidelines.

For example, if the AI engine 108 identifies a syntax error related to classification markings, the LLM may generate an explanation such as: “The classification marking on page 3 does not comply with the required format specified in Policy Document X. The correct format should be [example of correct format].”

Similarly, for policy non-compliance issues, the AI engine 108 may provide detailed explanations. For instance: “The technology described in paragraph 2 on page 5 may not be suitable for external disclosure according to Policy Document Z, which restricts sharing of this specific technology with external parties.”

In some cases, the graphical user interface 200 may allow users to select which LLM the AI engine 108 should use for a particular document review process. This feature may enable users to choose an LLM that is best suited for their specific review needs or that complies with any relevant organizational or security requirements.

The AI engine 108 may work in conjunction with other components of the document review and approval system. For example, the AI engine 108 may use the objectives defined through the objective definer elements 204 to guide its analysis of source documents and policy documents. Similarly, the AI engine 108 may leverage the corpus of policy documents selected through the corpus selector element 214 and corpus uploader element 216 to inform its policy compliance checks.

The document review and approval system may include a policy auditor 112. FIG. 1 illustrates the policy auditor 112 as part of the output interfaces of a document review and approval system.

In some cases, the policy auditor 112 may be configured to identify non-compliance issues with policies. The policy auditor 112 may analyze the content of source documents received through the source selector 102 and compare it against policy documents selected using the corpus selector 106.

FIG. 2D shows a graphical user interface 200 that includes a policy auditor element 218. The policy auditor element 218 may allow users to initiate the policy compliance check after selecting or uploading relevant policy documents through the corpus selector element 214 and corpus uploader element 216.

The policy auditor 112 may leverage the AI engine 108 to perform sophisticated analysis of document content. In some cases, the policy auditor 112 may be configured to identify non-compliance issues by comparing content of the source documents against the policy documents using natural language processing. This approach may enable the policy auditor 112 to detect both explicit and implicit policy violations.

For example, the policy auditor 112 may identify explicit violations such as the presence of specific prohibited terms or phrases. Additionally, the policy auditor 112 may detect implicit violations by inferring policy non-compliance through a deep understanding of the content. For instance, the policy auditor 112 may recognize that a description of a particular technology, even if not explicitly named, violates a policy restricting the disclosure of certain capabilities.

FIG. 2E illustrates a graphical user interface 200 that includes a finding presenter 220. The finding presenter 220 may display policy-related findings for the document being reviewed. In some cases, the finding presenter 220 may organize findings by page numbers or other relevant categories.

The graphical user interface 200 may also include finding indicators 222. The finding indicators 222 may appear as warning symbols or other visual cues next to specific highlighted content within the document that corresponds to the findings in the finding presenter 220.

FIG. 2F shows a graphical user interface 200 that includes a policy presenter 224. The policy presenter 224 may display the relevant policy document corresponding to the findings. Within the policy presenter 224, a policy indicator 226 may be visible, which may emphasize specific policy sections or clauses pertinent to the document review.

In some cases, the system may allow users to take arbitrary actions on findings. These actions may include removing a finding, adding comments to a finding, or editing and refining a finding using the AI engine 108. This functionality may provide users with flexibility in managing and responding to identified policy non-compliance issues.

In some cases, the document review and approval system may allow users to create new findings by interacting directly with the document presenter 206. Users may draw selection boxes around arbitrary portions of text within the document being reviewed. This feature may provide a flexible way for users to identify and analyze specific sections of a document that may require closer examination or raise potential compliance concerns.

After selecting a portion of text, users may have multiple options for creating a new finding. In some aspects, users may input custom text to describe the potential issue or concern related to the selected text. This user-defined text may be associated with the selected portion of the document and added as a new finding in the finding presenter 220.

Alternatively, users may leverage the AI engine 108 and semantic search capabilities to analyze the selected text for potential policy compliance issues. In this case, the system may automatically search the corpus of policy documents for relevant policies that may apply to the selected text. The AI engine 108 may then generate a finding based on its analysis, which may include potential policy violations or areas of concern.

The semantic search functionality may allow for a more nuanced and context-aware analysis of the selected text. For example, if a user selects a paragraph describing a technical capability, the AI engine 108 may search for policies related to the disclosure of that specific type of technology, even if the exact terms are not used in the policy documents.

In some cases, the system may present users with a combination of AI-generated findings and the option to add custom text. This approach may allow users to benefit from the AI's analysis while also incorporating their own expertise and insights.

The newly created findings, whether user-defined or AI-generated, may be added to the finding presenter 220 and associated with the corresponding portion of the document. Finding indicators 222 may be automatically added to the document presenter 206 to visually mark the location of these new findings within the document.

Users may have the ability to edit, refine, or remove these newly created findings using the same mechanisms available for system-generated findings. This may include using the finding remover element 230 or leveraging the AI engine 108 to further analyze or refine the finding.

By allowing users to create custom findings and leverage AI-powered analysis for selected text, the document review and approval system may provide a more interactive and thorough review process. This feature may enable reviewers to identify and address potential compliance issues that may not have been automatically detected by the system's initial analysis.

The policy auditor 112 may work in conjunction with other components of the document review and approval system. For example, the policy auditor 112 may use the objectives defined through the objective definer elements 204 to guide its analysis and prioritize certain types of policy compliance checks.

By combining advanced NLP capabilities with a comprehensive policy corpus and user-friendly interfaces, the policy auditor 112 may provide a thorough and nuanced assessment of document compliance with relevant policies.

The document review and approval system may include a reporter 114. FIG. 1 illustrates the reporter 114 as part of the output interfaces of a document review and approval system.

In some cases, the reporter 114 may be configured to generate reports based on findings of the syntax auditor 110 and/or the policy auditor 112. The reporter 114 may compile the results of the document review process into various types of reports, summaries, and memorandums.

FIG. 2G shows a graphical user interface 200 that includes elements related to the reporting functionality. The graphical user interface 200 may include a finding selector 228, which may display individual findings related to policy reviews. Each finding in the finding selector 228 may be presented in a box with descriptive text and associated document information.

In some cases, the graphical user interface 200 may include a finding remover element 230. The finding remover element 230 may be a button and allow users to remove specific findings from consideration before generating a report.

The graphical user interface 200 may also include a report generator element 232. The report generator element 232 may be a button, and selecting the report generator element 232 may trigger the creation of one or more reports related to the document review process.

In some cases, the reporter 114 may be configured to generate a summary memorandum based on the findings of the policy auditor 112. This summary memorandum may provide a concise overview of the policy compliance status of the reviewed document. The summary memorandum may include:
1. An executive summary of the review process
2. A list of identified policy compliance issues
3. Recommendations for addressing non-compliance issues
4. References to relevant policy documents

The reporter 114 may generate different types of reports depending on the user's needs and the specific review process. For example:
1. Detailed Compliance Report: This report may provide an in-depth analysis of all syntax and policy compliance issues identified during the review process. The report may include specific references to the source document, relevant policy documents, and explanations for each finding.
2. Executive Summary: This report may offer a high-level overview of the review process, highlighting key findings and recommendations. The executive summary may be suitable for stakeholders who need a quick understanding of the document's compliance status.
3. Approval Workflow Report: This report may document the steps taken in the review process, including who reviewed the document, what findings were identified, and how they were addressed. This report may be useful for maintaining an audit trail of the approval process.
4. Comparative Analysis Report: If multiple versions of a document are reviewed, the reporter 114 may generate a report comparing the compliance status of different versions, highlighting improvements or new issues that arise between versions.

In some cases, the reporter 114 may enable users to share revised documents, findings, and stamp or mark source documents as approved in accordance with defined approver workflows. The reporter 114 may generate approval stamps or markings that can be applied directly to the source documents, indicating their review status and approval.

The reporter 114 may work in conjunction with other components of the document review and approval system. For example, the reporter 114 may use the objectives defined through the objective definer 104 to tailor the content and format of the generated reports. Similarly, the reporter 114 may leverage the AI engine 108 to generate natural language summaries and explanations within the reports.

By providing a range of reporting options and the ability to customize report content based on user needs, the reporter 114 may facilitate effective communication of review results and support informed decision-making in the document approval process.

The document review and approval system may integrate various components to perform comprehensive document review and approval processes. FIG. 1 illustrates a block diagram of the document review and approval system, showing the interconnected components that work together to facilitate the review workflow.

In some cases, the workflow may begin with the source selector 102. The source selector 102 may allow users to input one or more documents for review. Once the documents are uploaded, the objective definer 104 may enable users to specify the goals and parameters of the review process.

The corpus selector 106 may then allow users to select relevant policy documents against which the source documents will be evaluated. In some cases, the corpus selector 106 may leverage the AI engine 108 to recommend relevant policy documents based on the defined objectives and the content of the source documents.

The AI engine 108 may process the inputs from the source selector 102, objective definer 104, and corpus selector 106. The AI engine 108 may analyze the source documents, interpret the user-defined objectives, and examine the selected policy documents to identify potential issues or areas of concern.

Following the analysis by the AI engine 108, the syntax auditor 110 may identify and facilitate correction of syntax errors in the source documents. The policy auditor 112 may then identify non-compliance issues with policies. Finally, the reporter 114 may generate reports based on the findings of the syntax auditor 110 and policy auditor 112.

In some cases, the document review and approval system may allow users to define rules based on plain English to be applied to a document that are general in nature. This functionality may be provided by a rule creation element of the user interface, which enables users to input rules in natural language without requiring technical expertise or programming knowledge. The rule creation element may include text input fields, dropdown menus, or other interactive components that facilitate the creation and editing of custom rules. These user-defined rules may be processed by the AI engine 108 and incorporated into the syntax auditor 110 and policy auditor 112 for document evaluation. The rule creation element enhances the flexibility of the system by allowing users to tailor the document review process to their specific requirements or organizational policies without requiring modifications to the underlying system architecture.

The document review and approval system may support workflows involving multiple users based on their respective responsibilities in a review and approval process. For example, one user may initiate the review process by uploading documents and defining objectives, while another user with different expertise may select relevant policy documents and review the findings.

In some cases, the system may create an ‘expert network’ of people responsible for approvals or topics based on previously approved documents by extracting metadata. The AI engine 108 may analyze the metadata from previously approved documents to identify patterns and relationships between document types, topics, and approvers. This expert network can include users from across an organization based on their respective knowledge, skills, seniorities, roles, and areas of expertise. The network can encompass various types of participants including reviewers with specialized technical knowledge, approvers with decision-making authority, subject matter experts, legal advisors, and others that may be needed to complete a particular workflow. The system may build redundancies into the expert network by identifying multiple qualified individuals for each role, ensuring that the review and approval process can proceed even if one or more of the designated experts is unavailable due to time constraints, conflicting priorities, or absence. This redundancy feature helps maintain operational continuity and prevents bottlenecks in the document review and approval process.

The system may assign others to review findings and documents by using the AI engine 108 to identify who experts might be within a given organization. For example, if a document contains technical information about a specific subject, the AI engine 108 may recommend reviewers who have previously approved similar documents or who have relevant expertise based on their profile information.

The document review and approval system may include access controls associated with documents and rules. These access controls may ensure that only authorized users can view, edit, or approve certain documents or apply specific rules during the review process.

A complete review process may involve multiple stages and users. For instance:
1. A requester may upload a document using the source selector 102 and define objectives using the objective definer 104.
2. The AI engine 108 may recommend relevant policy documents, which a policy expert may review and select using the corpus selector 106.
3. The syntax auditor 110 may identify syntax errors, which the requester may correct using the autofix element 212.
4. The policy auditor 112 may identify policy compliance issues, which a subject matter expert may review using the finding presenter 220.
5. The subject matter expert may use the finding remover element 230 to remove any false positives or resolved issues.
6. Finally, an approver may use the report generator element 232 to generate a final report summarizing the review process and findings.

Throughout this process, the graphical user interface 200 may guide users through each stage, ensuring a streamlined and comprehensive review workflow. By integrating these various components and supporting multi-user workflows, the document review and approval system may provide a flexible and powerful tool for ensuring document compliance with both syntax and policy requirements.

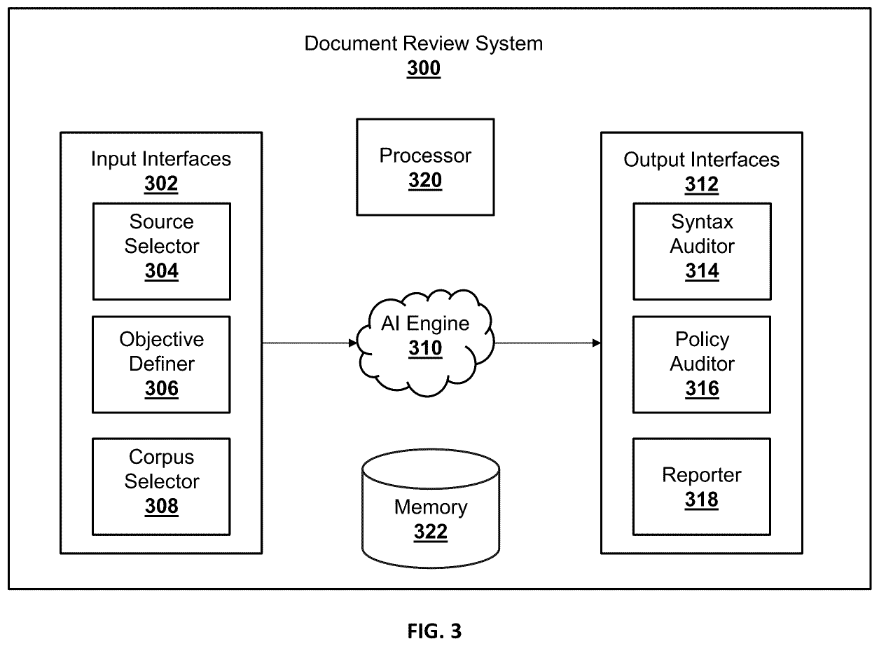

FIG. 3 illustrates a system diagram of a document review system 300. The document review system 300 may include various input interfaces 302, which may serve as the primary point of input interaction for users. The input interfaces 302 may incorporate graphical user interface elements and functionalities described in the earlier figures, such as the workflow progression indicators, document presenters, and interactive elements for managing the review process.

The input interfaces 302 may comprise three input components: a source selector component 304, an objective definer component 306, and a corpus selector component 308.

The source selector component 304 may enable users to input or select documents for review. This component may incorporate functionalities such as file uploading, drag-and-drop capabilities, and selection of documents from various sources as described in relation to the source selector element 202 in FIG. 2A.

The objective definer component 306 may allow users to specify the goals and parameters of the review process. This component may include various input fields, dropdown menus, and selection options as illustrated in the objective definer elements 204 in FIG. 2B. The objective definer component 306 may capture information such as intended recipients, approvers, target allies, disclosure methods, and justifications for the review process.

The corpus selector component 308 may facilitate the selection and management of relevant policy documents. This component may incorporate functionalities described in relation to the corpus selector element 214 and corpus uploader element 216 in FIG. 2D, such as searching for policy documents, uploading new documents, and managing the corpus of policies used in the review process.

At the core of the document review system 300 is an AI engine 310. This component may correspond to the AI engine 108 described earlier and may be responsible for processing inputs from the source selector component 304, objective definer component 306, and corpus selector component 308. The AI engine 310 may employ advanced natural language processing techniques, including large language models, to analyze documents, interpret user objectives, and evaluate policy compliance.

The AI engine 310 may be connected to the graphical user interface's multiple output interfaces 312, which may include a syntax auditor component 314, a policy auditor component 316, and a reporter component 318.

The syntax auditor component 314 may be responsible for identifying and facilitating the correction of syntax errors in the reviewed documents. This component may incorporate functionalities such as those described in relation to the syntax error presenter 208 and autofix element 212 in FIG. 2C. The syntax auditor 314 may highlight syntax issues within documents and provide options for automatic correction.

The policy auditor component 316 may identify non-compliance issues with policies. This component may leverage the AI engine 310 to compare document content against selected policy documents using natural language processing techniques. The policy auditor component 316 may incorporate functionalities described in relation to the finding presenter 220 and finding indicators 222 in FIG. 2E and FIG. 2F, such as displaying policy-related findings and highlighting areas of concern within documents.

The reporter component 318 may generate various types of reports based on the findings of the syntax auditor component 314 and policy auditor component 316. This component may incorporate functionalities described in relation to the report generator element 232 in FIG. 2G. The reporter component 318 may produce different types of reports, such as detailed compliance reports, executive summaries, approval workflow reports, and comparative analysis reports.

The interconnected nature of these components in FIG. 3 may enable a comprehensive and flexible document review process. For example, the AI engine 310 may use inputs from the objective definer component 306 to guide its analysis in the syntax auditor component 314 and policy auditor component 316. Similarly, the reporter component 318 may leverage information from all other components to generate tailored and informative reports.

The document review system 300 may include a processor 320 and memory 322 as core components that enable the system's functionality. The processor 320 may be responsible for executing instructions and performing computations necessary for the operation of various system components. In some cases, the processor 320 may be a central processing unit (CPU), a graphics processing unit (GPU), or a combination of multiple processing units working in parallel.

The memory 322 may serve as a storage medium for both the system's operational data and the machine-executable program code that defines the system's functionality. In some aspects, the memory 322 may include volatile memory, such as random-access memory (RAM), for temporary data storage during system operation. The memory 322 may also incorporate non-volatile memory, such as read-only memory (ROM) or flash memory, to store persistent data and program code.

The memory 322 may store data in various formats and structures to accommodate different types of information and optimize system performance. In some cases, the memory 322 may utilize relational databases to store structured data with predefined schemas. These relational databases may organize information into tables with rows and columns, allowing for efficient querying and data manipulation using SQL (Structured Query Language).

In other aspects, the memory 322 may employ NoSQL databases to handle unstructured or semi-structured data. Document-oriented databases, for example, may store data in flexible, JSON-like documents, which may be particularly useful for managing complex, hierarchical information related to document reviews and policy compliance.

The processor 320 and memory 322 may work in conjunction to support the operations of the input interfaces 302, AI engine 310, and output interfaces 312. For instance, the processor 320 may execute the machine-executable program code stored in the memory 322 to process user inputs, perform document analysis, and generate outputs through the various system components.

In some implementations, the memory 322 may store the corpus of policy documents, user-defined rules, and historical data used by the AI engine 310 for document analysis and policy compliance checking. The processor 320 may access this data from the memory 322 as needed during the document review process.

The document review system 300 may support multi-user workflows by allowing different users to interact with various components based on their roles and expertise. For instance, a requester may interact primarily with the source selector component 304 and objective definer component 306, while a policy expert may focus on the corpus selector component 308 and policy auditor component 316. Users can create and customize these workflows through a workflow designer interface that allows for visual mapping of approval chains, parallel review paths, and conditional routing based on document attributes or review outcomes. The system enables administrators to define role-based permissions that control which users can access, modify, or approve specific document types or sections. These permissions can be granularly assigned at the document, section, or even paragraph level to ensure sensitive information is only accessible to authorized personnel. The system incorporates comprehensive alerting functionality that automatically notifies relevant stakeholders when documents require their attention, when deadlines are approaching, or when changes have been made to documents under review. These alerts can be delivered through multiple channels including email, in-system notifications, or integration with messaging platforms. Additionally, the system provides robust change tracking and management capabilities that maintain a complete audit trail of all modifications, comments, and approvals throughout the document lifecycle. Each change can be timestamped and attributed to specific users, allowing for accountability and enabling reviewers to compare document versions or roll back to previous states if necessary. The system also supports collaborative review sessions where multiple users can simultaneously examine and comment on documents in real-time, with changes visible to all participants immediately.

The system may also incorporate access controls to ensure that only authorized users can view, edit, or approve certain documents or apply specific rules during the review process. These access controls may be managed through the input interfaces 302 and enforced by the AI engine 310 across all components of the system.

By integrating these various components and enabling their interaction through the AI engine 310, the document review system 300 may provide a powerful and flexible tool for ensuring document compliance with both syntax and policy requirements. The system may streamline the review process, reduce errors, and facilitate informed decision-making in document approval workflows.

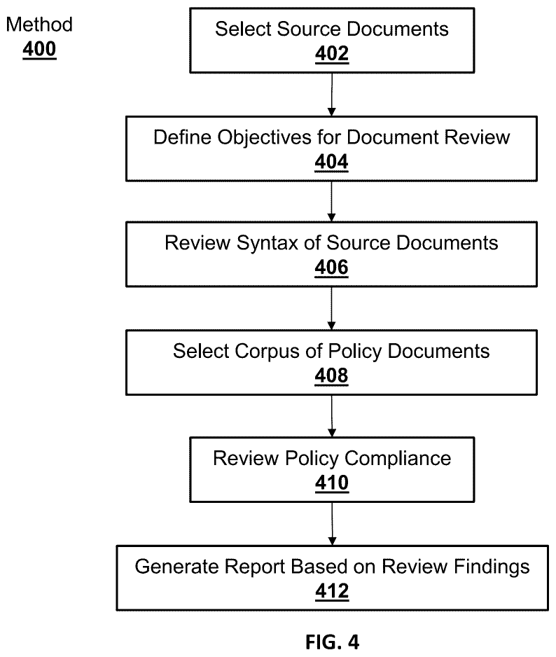

FIG. 4 illustrates a flowchart of a method for document review and approval using the system described herein. The method includes multiple stages that guide users through a comprehensive review process.

At step 402, the method begins with source selection. The user interface presents a source selector element as shown in FIG. 2A, allowing users to upload or select source documents for review through multiple input methods, including clicking to upload or using drag-and-drop functionality.

At step 404, the method proceeds to objective definition. The user interface transitions to an objective definition stage as illustrated in FIG. 2B, where users interact with various objective definer elements to specify review goals, such as selecting target recipients, setting target release dates, indicating disclosure methods, and entering justifications.

At step 406, the method advances to syntax review. The user interface presents a syntax review stage as depicted in FIG. 2C, displaying the content of the source document alongside identified syntax errors. Users can review these errors and use an autofix element to automatically correct them, with syntax error indicators highlighting issues within the document.

At step 408, the method continues with corpus selection. The user interface focuses on corpus selection as shown in FIG. 2D, where users interact with corpus selector elements to choose relevant policy documents and can add new policy documents using the corpus uploader element. Users then initiate the policy audit using a policy auditor element.

At step 410, the method moves to policy review. The policy review stage, illustrated in FIG. 2E and FIG. 2F, presents a split interface showing document content and a finding presenter that lists policy-related findings. Finding indicators highlight areas of concern within the document, while a policy presenter shows relevant policy documents with policy indicators emphasizing specific policy sections.

At step 412, the method concludes with report generation. The final stage, as depicted in FIG. 2G, focuses on report generation where users interact with a finding selector to review and manage findings. Users can exclude specific findings using finding remover elements and, once finalized, activate a report generator element to create the review report. Throughout all stages, the user interface displays a workflow progression indicator to help users track their position in the review process. The method provides a structured, intuitive approach to document review and approval while leveraging AI-powered analysis and auditing capabilities.

It should be understood that the stages of FIG. 4 are presented in a particular order as just one embodiment, but the stages can be implemented in different orders, combined into fewer stages, or expanded into additional stages as part of the same or additional embodiments. The system is designed with flexibility to accommodate various workflow configurations while maintaining the core functionality of document review and compliance checking.

The method illustrated in FIG. 4 may be implemented on a computer system and may be integrated into any of the document review and approval systems disclosed herein. In some aspects, the method may be executed by one or more processors in conjunction with computer-readable instructions stored on non-transitory computer-readable media. The computer system may include various hardware components such as memory devices, storage units, input/output interfaces, and network communication modules that work together to perform the steps of the method.

In some cases, the method may be implemented as part of the document review system 300 shown in FIG. 3. The steps of the method may correspond to operations performed by different components of the system. For example, the source selection step 402 may be carried out by the source selector component 304, while the objective definition step 404 may be handled by the objective definer component 306. The syntax review step 406 and policy review step 410 may be performed by the syntax auditor component 314 and policy auditor component 316 respectively, with support from the AI engine 310. The corpus selection step 408 may be managed by the corpus selector component 308, and the report generation step 412 may be executed by the reporter component 318.

The method may also be implemented in conjunction with the user interfaces illustrated in FIG. 2A through FIG. 2G. Each step of the method may correspond to a different interface or screen presented to the user, guiding them through the document review and approval process. The workflow progression indicator shown in these figures may reflect the current step of the method being executed.

In some aspects, the user interfaces, methods, and systems presented herein may be embodied in hardware, software, firmware, or a combination thereof. The software and firmware may include non-transitory machine executable code stored on a computer-readable medium. The non-transitory machine executable code may include various modules corresponding to different system components. For example, there may be separate modules for document parsing, syntax analysis, policy compliance checking, and report generation. These modules may communicate through well-defined APIs, allowing for modular development and easier maintenance.

When executed by a computer processor, the code may initiate the system's components and establish necessary connections between them. It may load the user interface in a custom application or the user's web browser, set up communication channels with the server-side components, and prepare the AI engine for document analysis tasks.

The non-transitory machine executable code may be written in any suitable programming language and may be stored on various types of non-transitory computer-readable media, such as magnetic disks, optical disks, solid-state drives, or other storage devices. The code may be compiled, interpreted, or executed by one or more processors to implement the functionalities of the document review and approval system.

In some cases, the system may be implemented using a client-server architecture, where the user interface components run on client devices while the AI engine and other processing components operate on one or more servers. Alternatively, the entire system may be implemented as a standalone application running on a single device.

The hardware components of the system may include one or more processors, memory devices, storage units, input/output interfaces, and network communication modules. These hardware components may work in conjunction with the software to present the user interfaces, process user inputs, perform document analysis, and generate outputs as described throughout this disclosure.

In some implementations, the system may be deployed in a cloud computing environment, allowing for scalability and distributed processing. The various components of the system may be implemented as microservices, each running in its own container and communicating with other components through well-defined APIs.

The user interfaces may be implemented using various web technologies, such as HTML, CSS, and JavaScript, allowing for cross-platform compatibility and accessibility through web browsers. Native desktop and/or mobile applications may also be developed to provide access to the system on personal computers, smartphones, and tablets.

The AI engine may be implemented using machine learning frameworks and libraries, which may be regularly updated to incorporate the latest advancements in natural language processing and document analysis techniques. The system may also include mechanisms for continuous learning and improvement based on user feedback and interaction data.

Security features, such as encryption for data in transit and at rest, may be implemented to protect sensitive information processed by the system. Access controls and authentication mechanisms may be integrated to ensure that only authorized users can access specific functionalities and documents within the system.

The use of the term “exemplary” in this disclosure may refer to “example” or “illustrative” and may not imply any preference or requirement. The use of the singular form of any word may include the plural and vice versa. Words importing a particular gender may include every other gender. The use of “or” may not be exclusive and may include “and/or” unless the context clearly dictates otherwise. The phrases “in one embodiment,” “in some embodiments,” “in various embodiments,” “in other embodiments,” and the like may all refer to one or more of the same or different embodiments. The term “based on” may mean “based at least in part on.” The term “may” may be used to describe optional features or functions. Any dimensions, measurements, or quantities given may be approximate and may vary within normal operational ranges. The use of relative terms such as “above,” “below,” “upper,” “lower,” “horizontal,” “vertical,” “top,” “bottom,” “side,” “left,” and “right” may be used to describe the relationship of one element to another and may not imply any particular orientation or direction unless specifically stated. The use of “including,” “comprising,” “having,” and variations thereof may mean “including, but not limited to” unless otherwise specified. Any sequence of steps or operations described may be varied or performed in a different order unless otherwise specified. Any numerical range recited may include all values from the lower value to the upper value and all possible sub-ranges in between. The term “about” or “approximately” may mean within an acceptable error range for the particular value as determined by one of ordinary skill in the art, which may depend in part on how the value is measured or determined.

A number of implementations have been described. Nevertheless, it will be understood that various modifications may be made without departing from the spirit and scope of the disclosure. Accordingly, other implementations are within the scope of the following claims.

1. A document review and approval system, comprising:
a processor;
a memory for storing machine executable program code;
a user interface component comprising machine executable program code that, when executed by the processor, causes the user interface component to display a graphical user interface;
a source selector component comprising machine executable program code that, when executed by the processor, causes the source selector component to receive one or more source documents selected by a user through the graphical user interface;
an objective definer component comprising machine executable program code that, when executed by the processor, causes the objective definer component to receive one or more user-defined objectives from the user for document review through the graphical user interface, wherein the one or more user-defined objectives include one or more intended recipients and one or more approvers;
a corpus selector component comprising machine executable program code that, when executed by the processor, causes the corpus selector component to receive one or more policy documents selected by the user through the graphical user interface, wherein the one or more policy documents include one or more policies related to permissible content;
an artificial intelligence engine component comprising machine executable program code that, when executed by the processor, causes the artificial intelligence engine component to process inputs from the source selector component, objective definer component, and corpus selector component and provide corresponding output;
a syntax auditor component comprising machine executable program code that, when executed by the processor, causes the syntax auditor component to identify one or more syntax errors in the one or more source documents based on the output from the artificial intelligence engine, wherein the one or more syntax errors include at least one of a formatting or structural error with the one or more source documents based on the one or more user-defined objectives;
a policy auditor component comprising machine executable program code that, when executed by the processor, causes the policy auditor component to identify one or more policy non-compliance issues related to the one or more source documents based on the output from the artificial intelligence engine, wherein the one or more policy non-compliance issues include content in the one or more source documents that is violative of one or more of the policies related to permissible content; and
a reporter component comprising machine executable program code that, when executed by the processor, causes the reporter component to generate one or more reports based on the identified syntax errors and policy non-compliance issues from the syntax auditor component and policy auditor component respectively.

2. The document review and approval system of claim 1, wherein the machine executable program code of the reporter component causes the reporter component to:
customize report content based on the one or more user-defined objectives received through the objective definer component; and
incorporate natural language summaries and explanations generated by the artificial intelligence engine component.

3. The document review and approval system of claim 1, wherein the machine executable program code of the corpus selector component causes the corpus selector component to semantically search across a database of policy documents to identify one or more relevant policy documents based on the one or more user-defined objectives.

4. The document review and approval system of claim 1, wherein the user interface component further comprises a document presenter component comprising machine executable program code that, when executed by the processor, causes the document presenter component to display content of the one or more source documents alongside identified syntax errors and policy non-compliance issues.

5. The document review and approval system of claim 1, wherein the artificial intelligence engine component comprises a large language model comprising machine executable program code that, when executed by the processor, generates natural language explanations for identified syntax errors and policy non-compliance issues.

6. The document review and approval system of claim 1, wherein the machine executable program code of the artificial intelligence engine component further causes the artificial intelligence engine component to recommend one or more relevant policy documents based on the content of the one or more source documents and the one or more user-defined objectives.

7. The document review and approval system of claim 1, wherein the machine executable program code of the artificial intelligence engine component further causes the artificial intelligence engine component to create an expert network by analyzing metadata from previously approved documents to identify patterns and relationships between document types, topics, and approvers.

8. The document review and approval system of claim 1, wherein the machine executable program code of the reporter component further causes the reporter component to generate approval stamps or markings and apply them directly to the one or more source documents to indicate their review status and/or approval.

9. The document review and approval system of claim 1, wherein the machine executable program code of the user interface component causes the user interface component to guide users through multiple stages of a review process, including selecting source documents, defining objectives, reviewing syntax errors, selecting a corpus, reviewing policy non-compliance, and generating reports.

10. The document review and approval system of claim 1, wherein the user interface component comprises a rule creation element comprising machine executable program code that, when executed by the processor, causes the rule creation element to allow users to define one or more rules in plain language, and wherein the machine executable program code of the artificial intelligence engine component causes the artificial intelligence engine component to process these one or more user-defined rules and incorporate them into one or more of the syntax auditor component and policy auditor component for document evaluation.

11. A method for document review and approval, comprising:
displaying a graphical user interface;
receiving, through the graphical user interface, one or more source documents selected by a user;
receiving, through the graphical user interface, one or more user-defined objectives from the user for document review, wherein the one or more user-defined objectives include one or more intended recipients and one or more approvers;
receiving, through the graphical user interface, one or more policy documents selected by the user, wherein the one or more policy documents include one or more policies related to permissible content;
processing, by an artificial intelligence engine, inputs from the received source documents, user-defined objectives, and policy documents;
identifying, based on output from the artificial intelligence engine, syntax errors in the one or more source documents, wherein the one or more syntax errors include at least one of a formatting or structural error with the one or more source documents based on the one or more user-defined objectives;
identifying, based on output from the artificial intelligence engine, policy non-compliance issues related to the one or more source documents, wherein the one or more policy non-compliance issues include content in the one or more source documents that is violative of one or more of the policies related to permissible content; and
generating one or more reports based on the identified syntax errors and policy non-compliance issues.

12. The method of claim 11, further comprising:
customizing report content based on the one or more user-defined objectives; and
incorporating natural language summaries and explanations generated by the artificial intelligence engine into the one or more reports.

13. The method of claim 11, further comprising:
semantically searching across a database of policy documents to identify one or more relevant policy documents based on the one or more user-defined objectives.

14. The method of claim 11, further comprising:
displaying content of the one or more source documents alongside identified syntax errors and policy non-compliance issues.

15. The method of claim 11, wherein the artificial intelligence engine comprises a large language model, and the method further comprises:
generating, by the large language model, natural language explanations for identified syntax errors and policy non-compliance issues.

16. The method of claim 11, further comprising:
recommending, by the artificial intelligence engine, one or more relevant policy documents based on the content of the one or more source documents and the one or more user-defined objectives.

17. The method of claim 11, further comprising:
creating, by the artificial intelligence engine, an expert network by analyzing metadata from previously approved documents to identify patterns and relationships between document types, topics, and approvers.

18. The method of claim 11, further comprising:
generating approval stamps or markings; and
applying the approval stamps or markings directly to the one or more source documents to indicate their review status and/or approval.

19. The method of claim 11, further comprising:
guiding users through multiple stages of a review process, including selecting source documents, defining objectives, reviewing syntax, selecting a corpus, reviewing policy compliance, and generating reports.

20. The method of claim 11, further comprising:
receiving, through the graphical user interface, one or more user-defined rules in plain language;
processing, by the artificial intelligence engine, the one or more user-defined rules; and
incorporating the processed user-defined rules into one or more of a syntax auditor and a policy auditor for document evaluation.
